(19) United States
(12) Patent Application Publication
(10) Pub. No.: US 2020/0197959 A1
(43) Pub. Date: Jun. 25, 2020

(54) NOZZLE FOR DISPERSING LIQUIDS, AND AGRICULTURAL SPRAY DEVICE

(71) Applicants: Wolfgang REMPP, Stuttgart (DE); Robert HEINKEL, Dettingen/Erms (DE)

(72) Inventors: Wolfgang REMPP, Stuttgart (DE); Robert HEINKEL, Dettingen/Erms (DE)

(21) Appl. No.: 16/718,668

(22) Filed: Dec. 18, 2019

(30) Foreign Application Priority Data
Dec. 21, 2018 (DE) 10 2018 222 769.1

(51) Int. Cl. B05B 1/14; A01C 23/04

(52) U.S. Cl. CPC B05B 1/14; A01C 23/047

(57) ABSTRACT

A nozzle for dispersing liquids having a housing with a liquids inlet, an exit chamber, and first, second and third exit ducts which proceed from the exit chamber. A longitudinal axis of the first exit duct lies in a central plane of the housing, a longitudinal axis of the second exit duct is disposed at a second angle to the central plane, and a longitudinal axis of the third exit duct is disposed at a third angle to the central plane. The third angle in terms of the value being identical to the second angle but in terms of the algebraic sign being different therefrom. A free cross section of the second exit duct and a free cross section of the third exit duct are dissimilar such that in the operation of the nozzle dissimilar quantities of liquid are discharged from the second exit duct and the third exit duct.

### CROSS REFERENCE TO RELATED APPLICATIONS

This claims priority from German Application No. 10 2018 222 769.1, filed Dec. 21, 2018, the disclosure of which is hereby incorporated by reference in its entirety.

### TECHNICAL FIELD

The invention relates to a nozzle for dispersing liquids, in particular liquid fertilizer, having a housing having a liquids inlet, an exit chamber, and at least a first exit duct, a second exit duct, and a third exit duct, wherein the exit ducts proceed from the exit chamber, wherein a longitudinal axis of the first exit duct lies in a central plane of the housing, wherein the second exit duct is disposed at a second angle to the central plane, and wherein the third exit duct is disposed at a third angle to the central plane, said third angle in terms of the value being identical to the second angle but in terms of the algebraic sign being different therefrom. The invention also relates to an agricultural spray device having a plurality of nozzles according to the invention.

### BACKGROUND

A liquid fertilizer nozzle which has a housing having a liquids inlet, an exit chamber and a total of five exit ducts which proceed from the exit chamber is known from European patent EP 1 416 785 B1. A first exit duct is disposed on the central longitudinal axis so as to be in alignment with the liquids inlet. The first exit duct runs so as to be parallel with the central longitudinal axis of the housing. The central longitudinal axis of the exit chamber lies in a central plane of the housing. A second exit duct is disposed at a second angle to the central plane, and a third exit duct is disposed at a third angle to the central plane, said third angle in terms of the value being identical to the second angle but in terms of the algebraic sign being different therefrom. A fourth exit duct is disposed at a fourth angle to the central plane, and a fifth exit duct is disposed at a fifth angle to the central plane, wherein the fourth and the fifth angle in terms of the value are identical but in terms of the algebraic sign are different, and wherein the fourth and the fifth angle are larger than the second and the third angle. A free cross section of the second and of the third exit duct are identical such that in the operation of the liquid fertilizer nozzle identical quantities of liquid are discharged from the second exit duct and the third exit duct. The free cross section of the fourth exit duct and of the fifth exit duct are also identical such that in the operation of the liquid fertilizer nozzle identical quantities of liquid are discharged from the fourth exit duct and the fifth exit duct. A total of five spray jets are thus discharged by the liquid fertilizer nozzle, a first spray jet from the first exit duct being parallel with the longitudinal axis of the exit chamber, a second and a third spray jet having identical quantities of liquid and at angles to the central plane that are identical in terms of the value, and a fourth and a fifth spray jet having identical quantities of liquid and at angles to the central plane that are identical in terms of the value.

A nozzle for dispersing liquids, in particular liquid fertilizer, and an agricultural spray device are to be improved with a view to an ideally optimal distribution of the discharged quantity of liquid fertilizer by way of the invention.

To this end, a nozzle having a housing with a liquids inlet, an exit chamber, and at least a first exit duct, a second exit duct, and a third exit duct is provided according to the invention, wherein the exit ducts proceed from the exit chamber, wherein a longitudinal axis of the first exit duct lies in a central plane of the housing, wherein the second exit duct is disposed at a second angle to the central plane, wherein the third exit duct is disposed at a third angle to the central plane, said third angle in terms of the value being identical to the second angle but in terms of the algebraic sign being different therefrom, in which a free cross section of the second exit duct and a free cross section of the third exit duct are dissimilar such that in the operation of the nozzle dissimilar quantities of liquid are discharged from the second exit duct and the third exit duct.

It has surprisingly been demonstrated that generating spray jets at angles to the central plane that are identical in terms of the value but different in terms of the algebraic sign and discharge dissimilar quantities of liquid, in use leads to an improved distribution of the quantity of liquid discharged by the spray jets. It is assumed that the spray jets generated at least in part and at least at times impact plants or obstacles and uneven features on the ground, and that the advantages of the nozzle according to the invention come to bear at such conditions.

In a refinement of the invention, a fourth exit duct and a fifth exit duct which proceed from the exit chamber are provided, wherein the fourth exit duct is disposed at a fourth angle to the central plane, wherein the fifth exit duct is disposed at a fifth angle to the central plane, wherein the fourth and the fifth angle are different from the second and the third angle, wherein the fourth and the fifth angle in terms of value are identical but in terms of the algebraic sign are different, and wherein a free cross section of the fourth exit duct and a free cross section of the fifth exit duct are dissimilar such that in the operation of the nozzle dissimilar quantities of liquid are discharged from the fourth exit duct and the fifth exit duct.

In a refinement of the invention, the free cross section of the second exit duct and the free cross section of the fourth exit duct are identical, and the free cross section of the third exit duct and the free cross section of the fifth exit duct are identical such that in the operation of the nozzle identical quantities of liquid are discharged from the second exit duct and the fourth exit duct, and that identical quantities of liquid are discharged from the third exit duct and the fifth exit duct.

An optimal distribution of the discharged quantity of liquid is achieved in this way. Spray jets which exit at angles which are identical in terms of value to the central plane discharge dissimilar quantities of liquid. However, the spray jet which exits at the second angle discharges the identical quantity of liquid as the spray jet which exits at the fourth angle, the latter being different from the second angle. The third spray jet discharges the identical quantity of liquid as the fifth spray jet which exits at an angle to the central plane that is different from that of the third spray jet. In total however, identical quantities of liquid are dispensed on the right and on the left of the central plane.

In a refinement of the invention, an aperture having at least one passage opening is disposed in the exit chamber, and the beginning of the first exit duct, when viewed in the flow direction through the exit chamber, is offset in relation to the passage opening.

Setting the total quantity of liquid discharged by the nozzle according to the invention is achieved by way of the aperture. The offset between the passage opening in the aperture and the beginning of the first exit duct, when viewed in the flow direction, prevents the jet of liquid generated in the aperture by the passage opening from performing a so-called clean shot, in other words prevents the jet of liquid from passing right through the first exit duct directly from the aperture. Rather, the jet of liquid generated by the aperture impacts the base of the exit chamber beside the beginning of the first exit duct such that a uniform distribution of the discharged quantity of liquid fertilizer by way of the plurality of exit ducts of the nozzle is guaranteed.

In a refinement of the invention, at least one of the exit ducts, when viewed perpendicularly to the central axis, is inclined by a sixth angle between 4° and 10°, in particular 7°, in relation to the central longitudinal axis of the housing.

On account thereof, exiting of liquid from the nozzle is performed obliquely, in particular in an oblique rearwards manner, such that the jets of liquid in the travelling operation of an agricultural spray device equipped with the nozzles impact the ground vertically.

In a refinement of the invention, all exit ducts in relation to the envisaged direction of movement are inclined towards the rear by the sixth angle.

In the travelling operation of an agricultural spray device equipped with the nozzles according to the invention it is ensured on account thereof that the spray jets generated meet the ground in a substantially perpendicular manner. The sixth angle herein is set as a function of a spacing of the nozzles above the ground and as a function of a usual travelling speed of an agricultural spray device.

In a refinement of the invention, the housing at the lower end thereof where the exit ducts open into the environment is provided with a protrusion which in an envisaged direction of movement lies in front and which protrudes from the housing approximately in the direction of the central longitudinal axis of the exit chamber.

On account of such a protrusion, a spout which protects the exit openings, thus the ends of the exit ducts from which the generated spray jets exit, against rebounding plants and thus against contamination and damage, is formed on the housing. The housing can moreover be provided with a mark indicating the envisaged direction of travel, for example an arrow mark indicating the direction of travel.

In a refinement of the invention, a cross section of at least one of the exit ducts is elliptic.

The provision of exit ducts having at least in portions an elliptic cross section has proven advantageous when comparatively large volumetric flows are to be discharged.

In a refinement of the invention, a major of the semi-axes of the ellipse is disposed so as to be parallel with the envisaged direction of movement of the liquid fertilizer nozzle.

In this way a spray jet having an elliptic cross section is generated which transversely to the envisaged direction of movement does however not required more space than a spray jet that is discharged from a circular exit opening. This is very advantageous in particular when liquid fertilizer is to be dispensed between rows of plants. On account of the elliptic cross section, the liquid can be spread in a planar manner, but the wetting of leaf faces is nevertheless limited.

The object on which the invention is based is also achieved by an agricultural spray device having a plurality of nozzles according to the invention in which the exit ducts in relation to a forward travel direction of the spray device are inclined towards the rear at a sixth angle between 40 and 100, in particular 7°.

It can be achieved in this way that the spray nozzles in the travelling operation of the agricultural spray device at a usual speed impact the ground vertically. The angle herein is chosen as a function of the envisaged travelling speed and as a function of the envisaged spacing of the nozzles above the ground.

Further features and advantages of the invention are derived from the claims and the description hereunder of preferred embodiments of the invention in conjunction with the drawings. Individual features of the different embodiments illustrated and described herein can be combined with one another in an arbitrary manner without departing from the scope of the invention. This also applies to the combination of individual features without other individual features in conjunction with which the former are described or illustrated.

### BRIEF DESCRIPTION OF THE DRAWINGS

In the drawings:

FIG. 1 shows a lateral view of a nozzle according to the invention, according to a first embodiment;

FIG. 2 shows a plan view of the nozzle of FIG. 1;

FIG. 3 shows a view of the nozzle of FIG. 1 from below;

FIG. 4 shows a reduced view of the nozzle of FIG. 1 from below, corresponding to FIG. 3;

FIG. 5 shows a lateral view, corresponding to FIG. 1;

FIG. 6 shows a view onto the section plane A-A in FIG. 4;

FIG. 7 shows a view onto the section plane C-C in FIG. 5;

FIG. 8 shows a view of the nozzle of FIG. 1, corresponding substantially to FIG. 1 but tilted in the anti-clockwise manner;

FIG. 9 shows a view of section profile A-A in FIG. 8;

FIG. 10 shows a view of the nozzle of FIG. 1 from the rear, thus from the left in FIG. 1;

FIG. 11 shows a view onto the section plane B-B in FIG. 10;

FIG. 12 shows a view of the nozzle of FIG. 1, rotated by 180° in relation to the illustration of FIG. 8;

FIG. 13 shows a view of the section profile C-C in FIG. 12;

FIG. 14 shows a lateral view of a nozzle according to the invention, according to a second embodiment;

FIG. 15 shows a plan view of the nozzle of FIG. 14;

FIG. 16 shows a view of the nozzle of FIG. 14 from below;

FIG. 17 shows a reduced view of the nozzle of FIG. 14 from below, corresponding to FIG. 16;

FIG. 18 shows a view of the nozzle of FIG. 14, corresponding to FIG. 15;

FIG. 19 shows a view onto the section plane B-B in FIG. 17;

FIG. 20 shows a view of the nozzle of FIG. 14, rotated in the anti-clockwise manner in relation to the view of FIG. 14;

FIG. 21 shows a view of the section profile D-D in FIG. 20;

FIG. 22 shows a view of the nozzle of FIG. 14 from the rear, thus from the left in FIG. 14;

FIG. 23 shows a view onto the section plane E-E in FIG. 22;

FIG. 24 shows a view of the nozzle of FIG. 14, rotated by 180° in relation to the illustration of FIG. 20;

FIG. 25 shows a view of the section profile F-F in FIG. 24; and

FIG. 26 shows a view onto the section plane F-F in FIG. 18.

### DETAILED DESCRIPTION

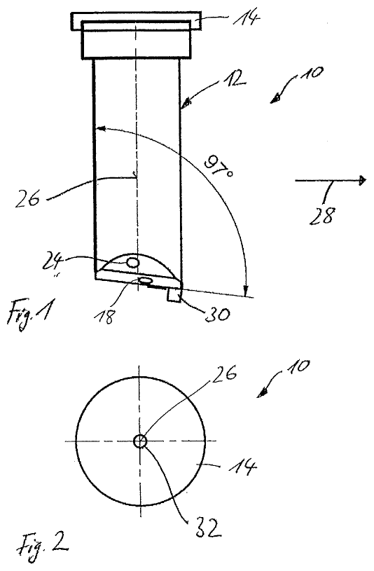

FIG. 1 shows a nozzle 10 according to the invention for dispersing liquids, in particular liquid fertilizer, according to a first embodiment of the invention. The nozzle 10 has a housing 12 which in an aperture 14 has a liquids inlet (not visible in FIG. 1), said aperture 14 being placed onto the upper end of the housing 12 in FIG. 1. An exit chamber (not visible in FIG. 1) is disposed in the housing 12.

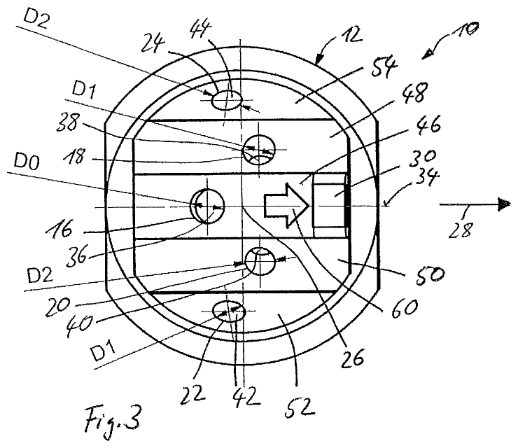

A total of five exit ducts proceed from the exit chamber, wherein only two exit openings 18, 24 where the respective exit ducts end can be seen in FIG. 1; cf. also FIG. 3.

The exit openings 18, 24 are in each case disposed in an oblique end face at the lower end of the housing 12, wherein the exit opening 18 is disposed in a first oblique end face, and the exit opening 24 is disposed in a further oblique end face, said oblique end faces being in each case disposed at a different angle to a longitudinal axis 26 of the exit chamber. A central plane of the housing 12 lies in the image plane in FIG. 1. The central plane contains the longitudinal axis 26 of the exit chamber.

A protrusion 30 is disposed at the lower end of the housing, so as to be in front in an envisaged direction of movement 28 of the nozzle 10. When the nozzle 10 is thus fastened to an agricultural spray device, the envisaged direction of movement during the spraying operation is thus predefined by the arrow 28. The protrusion 30 in this instance forms a spout which lies in front in the direction of travel and which is provided for protecting the exit openings 18, 24 as well as also the further exit openings that cannot be seen in FIG. 1 against contamination and damage by rebounding plants.

FIG. 2 shows a plan view of the nozzle 10 of FIG. 1. The aperture 14 having a central passage opening 32 can be seen. The passage opening 32 simultaneously forms the liquids inlet to the exit chamber in the housing 12. It is evident in FIG. 2 in which the view onto the nozzle is in parallel with the longitudinal axis 26 of the exit chamber that none of the total of five exit openings 16 to 24 can be seen through the passage opening 32; cf. also FIG. 3. This is because the first exit opening 16, the exit duct assigned thereto lying in a central plane 34 of the housing 12, when viewed in the direction of the longitudinal axis 26, is offset in relation to the passage opening 32. In the operation of the nozzle 10 it can be prevented on account thereof that a jet of liquid generated by the passage opening 32 and entering the exit chamber cleanly shoots through. This is because such a jet of liquid impacts a lower delimitation wall of the exit chamber such that the so-called clean shot and thus excessive dispensing of liquid by way of the first exit opening 16 is avoided.

FIG. 3 shows a view of the nozzle 10 of FIG. 1 from below.

As has been explained, a total of five exit openings 16, 18, 20, 22, and 24, which are in each case disposed at the end of exit ducts, are provided, wherein the exit ducts in turn proceed from the exit chamber in the interior of the housing 12. The first exit opening 16 is disposed at the end of a first exit duct 36. The first exit duct 36 has a circular cross section having the diameter D0. The second exit opening 18 is disposed at the end of a second exit duct 38 which has a circular cross section having the diameter D1. The third exit opening 20 is disposed at the end of a third exit duct 40 which has a circular cross section having a diameter D2. The fourth exit opening 22 is disposed at the end of a fourth exit duct 42 which has a circular cross section having the diameter D1. The fifth exit opening 24 is disposed at the end of a fifth exit duct 44 which has a circular cross section having the diameter D2.

When viewed relative to the central plane 34, the longitudinal axis of the first exit duct 36 lies in the central plane 34. In terms of the envisaged direction of movement 28 of the nozzle 10, the longitudinal axis of the first exit duct 36 is additionally inclined to the rear by 7°. Since the view in FIG. 3 is illustrated so as to be parallel with the longitudinal axis 26 of the exit chamber and the envisaged direction of movement 28 points to the right, the first exit duct 36 in the illustration of FIG. 3 runs in a slightly oblique manner to the left.

When viewed relative to the central plane 34, the second exit duct 38 is disposed at a second angle to the central plane 34. Moreover, the longitudinal axis of the second exit duct 38 is likewise inclined by an angle of 7°, counter to the envisaged direction of movement 28. The second exit duct in the illustration of FIG. 3, thus when viewed so as to be parallel with the longitudinal axis 26 of the exit chamber, therefore runs obliquely upward and slightly to the left.

The third exit duct 40 is by a third angle inclined to the central plane 34 and additionally by 7° towards the rear, counter to the envisaged direction of movement 28. The third angle in terms of the value is identical to the second angle but in terms of the algebraic sign is different therefrom. The longitudinal axes of the first exit duct 38 and of the third exit duct 40 are thus disposed so as to be symmetrical with the central plane 34. The third exit duct 40 in the illustration of FIG. 3 thus runs downwards and slightly to the left. The second exit duct 38 however has a circular cross section having the diameter D1, whereas the third exit duct 40 has a circular cross section having the diameter D2. In the operation of the nozzle 10 a quantity of liquid is discharged from the second exit duct 38 that is thus different from that from the third exit duct 40. In the case of the embodiment illustrated the diameter D1 is larger than the diameter D2.

A longitudinal axis of the fourth exit duct 42 is inclined to the central plane 34 by a fourth angle which is larger than the third angle. The fourth exit duct 42 moreover in relation to the longitudinal axis 26 is inclined towards the rear by an angle of 7°, thus counter to the envisaged direction of movement 28. The fourth exit duct 42 in the illustration of FIG. 3 thus runs intensely downwards and slightly to the left. The fourth exit duct 42 has a circular cross section having the diameter D1. The cross section of the fourth exit duct 42 thus corresponds to the cross section of the second exit duct 38.

The fifth exit duct 44 in relation to the central plane 34 is inclined by a fifth angle and is additionally inclined by an angle of 7° to the longitudinal axis 26, counter to the direction of movement 28. The fifth angle in terms of the value is identical to the fourth angle but in terms of the algebraic sign is different therefrom. The longitudinal axes of the fourth exit duct 42 and of the fifth exit duct 44 are thus disposed so as to be symmetrical with the central plane 34. The fifth exit duct 44 in the illustration of FIG. 3 thus runs intensely upwards and slightly to the left. The fifth exit duct 44 has a circular cross section having the diameter D2. The fifth exit duct 44 thus has a free cross section that is different from that of the fourth exit duct 42.

Dissimilar quantities of liquid are thus discharged from the third exit duct 42 and the fourth exit duct 44 in the operation of the nozzle 10. The free cross section of the fifth exit duct 44 is equal in size to the free cross section of the third exit duct 40. Identical quantities of liquid are thus discharged from the third exit duct 40 and the fifth exit duct 44 in the operation of the nozzle 10. Identical quantities of liquid are also discharged from the second exit duct 38 and the fourth exit duct 42. The diameter D0 is larger than the diameter D1 and larger than the diameter D2. The diameter D1 is larger than the diameter D2.

On account of the nozzle 10 according to the invention, spray jets having identical quantities of liquid are thus discharged from the second exit duct 40 and the fifth exit duct 44 in the operation of the nozzle. However, these two spray jets are disposed at dissimilar angles to the central plane 34. Spray jets having identical quantities of liquid are also discharged from the second exit duct 38 and the fourth exit duct 42 when the nozzle 10 is in operation. However, these spray jets are discharged at dissimilar angles to the central plane 34.

The first exit opening 16 is disposed in a first end face 46 of the housing 12, said first end face 46 being disposed so as to be perpendicular to the central plane 34 but being inclined by 7° in relation to the longitudinal axis 26. As is plotted in FIG. 1, the first end face 46 is thus disposed at an angle of 97° to the longitudinal axis 26. Since the first exit duct 36 is also inclined by 7° in relation to the longitudinal axis, the first exit duct 36 meets the first end face 46 in a perpendicular manner.

The second exit opening 18 is disposed in a second end face 48 of the housing 12, said second end face 48 being disposed so as to be inclined at the second angle to the central plane 34. Additionally, the second end face 48 is inclined by an angle of 7° counter to the envisaged direction of movement 28 and is thus inclined to the longitudinal axis 26; see also FIG. 1. Since the longitudinal axis of the second exit duct 38 is disposed at the second angle to the central plane 34 and so as to be inclined by 7° to the central axis 26, the second exit duct 38 meets the second end face 48 in an orthogonal manner.

The third exit opening 20 is disposed in a third end face 50 of the housing 12. The third end face 50 is inclined by the third angle to the central plane 34, and is additionally inclined towards the rear by 7° to the longitudinal axis 26. The third exit duct 40 thus meets the third end face 50 in a perpendicular manner.

The fourth exit opening 22 is disposed in a fourth end face 52 of the housing 12, said fourth end face 52 being inclined at the fourth angle to the central plane 34, and additionally being inclined by 7° in relation to the longitudinal axis 26, counter to the direction of movement 28. The fourth exit duct 42 thus meets the fourth end face 52 in a perpendicular manner.

The fifth exit opening 24 is disposed in a fifth end face 54 of the housing 12, said fifth end face 54 being inclined by the fifth angle to the central plane 34, and additionally being inclined by 7° to the longitudinal axis 26, counter to the direction of movement 28. The fifth exit duct 44 thus meets the fifth end face 54 in a perpendicular manner.

All exit ducts 36, 38, 40, 42, and 44 thus meet the respectively assigned end faces 46, 48, 50, 52, and 54 in a perpendicular manner. All exit ducts 36, 38, 40, 42, 44 have a circular cross section. All exit openings 16, 18, 20, 22, 24 are thus circular.

An arrow mark 60 which indicates the envisaged direction of movement 28 of the nozzle 10 is provided in the first end face 46. The protrusion 30 is disposed on that end of the first end face 46 that is at the front in the envisaged direction of movement 28.

The illustration of FIG. 4 in a manner corresponding to FIG. 3 shows a reduced view of the nozzle of FIG. 1, wherein a section plane A-A is also additionally plotted. The section plane A-A runs so as to be parallel with an envisaged direction of movement of the nozzle 10 in the spraying operation of a self-driving field sprayer provided with the nozzle 10, or of a spraying installation installed in a tractor or hitched thereto, contains the central longitudinal axis of the nozzle 10, and in the operation of the nozzle 10 is disposed so as to be perpendicular to a ground surface.

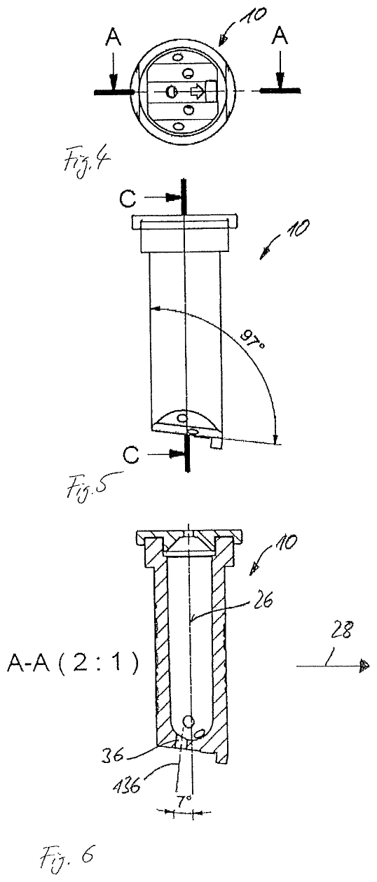

FIG. 5 shows a view of the nozzle 10 corresponding to that of FIG. 1, wherein a section plane C-C is additionally plotted. The section plane C-C runs so as to be perpendicular to an envisaged direction of movement of the nozzle 10 in the spraying operation, contains the central longitudinal axis of the nozzle 10, and in the operation of the nozzle 10 is disposed so as to be perpendicular to a ground surface.

FIG. 6 shows a view of the section plane A-A in FIG. 4. It can be seen in this view that a longitudinal axis 136 of the exit duct 36 is inclined by 7° to the central longitudinal axis 26 of the nozzle 10. The longitudinal axes of the exit ducts 38, 40, 42, and 44 are also inclined by 7° to the central longitudinal axis 26, specifically in the same direction as the longitudinal axis 136 of the exit duct 36. In relation to the envisaged direction of movement 28, the spray jets exiting the exit ducts 36, 38, 40, 42, 44, or the respectively assigned exit openings 16, 18, 20, 22, 24, respectively, on account thereof exit the nozzle 10 so as to be inclined towards the rear by 7° to the vertical which is perpendicular to the ground surface. It can be achieved on account thereof that the spray jets generated in the case of usual travelling speeds of a field sprayer or any other agricultural spray device which is equipped with the nozzles 10 impact a ground surface perpendicularly.

It is plotted in FIG. 1 and FIG. 5 that the planes 46, 48, 50, 52, and 54 in which the exit openings 16, 18, 20, 22, and 24, respectively, are disposed are inclined by 97° to the central longitudinal axis 26. Consequently, the longitudinal axis 136 of the exit duct 36 and also the longitudinal axes of the exit ducts 38, 40, 42, and 44 meet the respective plane 46, 48, 50, 52, and 54, respectively, in a perpendicular manner. On account thereof, the spray jet generated can be cleanly released in a uniform manner from the respective exit opening 16, 18, 20, 22, and 24, respectively, and is substantially symmetrical with the respective longitudinal axis 136.

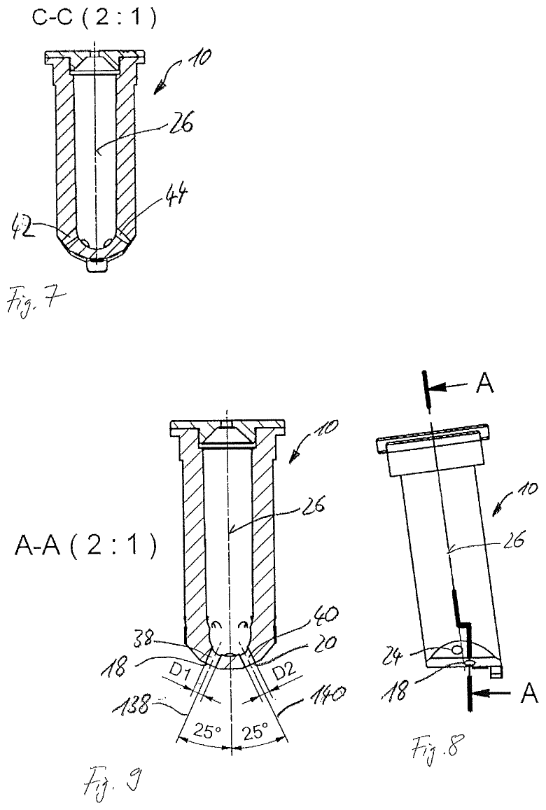

FIG. 7 shows a view of the section plane C-C in FIG. 5. The two exit ducts 42, 44 can be seen in portions in this sectional view. The longitudinal axes of the exit ducts 42, 44 are inclined by an angle of ±50° to the central longitudinal axis 26 of the liquid fertilizer nozzle 10, wherein the longitudinal axes of the exit ducts 42, 44 are not illustrated in FIG. 7.

FIG. 8 shows a lateral view of the nozzle 10 which in relation to the lateral view of FIG. 5 has been tilted by 7° in the anti-clockwise manner. The central longitudinal axis 26 of the nozzle 10 in FIG. 8 thus runs so as to be inclined by 7° to the vertical, in the anti-clockwise manner. A section profile A-A which initially runs such that the section face to short of the exit openings 24, 18 runs such that said section face contains the central longitudinal axis 26 but then has a step, and runs through the exit opening 18 as well as through the exit opening 20 (not illustrated) so as to be parallel to the longitudinal axis of said exit opening 18 is plotted in FIG. 8.

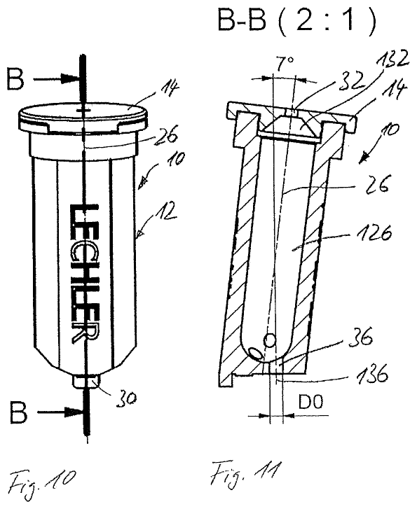

FIG. 9 shows a view onto the section profile A-A in FIG. 8. To be seen are the longitudinal axes 138, 140 of the exit ducts 38, 40. Said longitudinal axes 138, 140 in the illustration of FIG. 9 are disposed by +25° and −25° to the central longitudinal axis 26. As has already been explained, the central longitudinal axis 26 in the assembled state of the nozzle 10 runs so as to be approximately perpendicular to a ground surface. The spray jets thus exit the exit openings 18, 20 so as to be inclined towards the rear by 7° as well as to laterally project from the exit openings 18, 20 by +25 or −25°, respectively. The exit duct 38 has the diameter D1 which is larger than the diameter D2 of the exit duct 40. More liquid thus exits from the exit duct 38 than from the exit duct 40 in the operation of the liquids nozzle 10. The spray pattern of the nozzle 10 is thus not symmetrical.

The illustration of FIG. 10 shows the nozzle 10 in a view from the rear such that the view thus runs in the envisaged direction of travel 28; see FIG. 1. The view onto the nozzle 10 in FIG. 1 is thus from the left. A section plane B-B which contains the central longitudinal axis 26 of the nozzle 10 is plotted in FIG. 10.

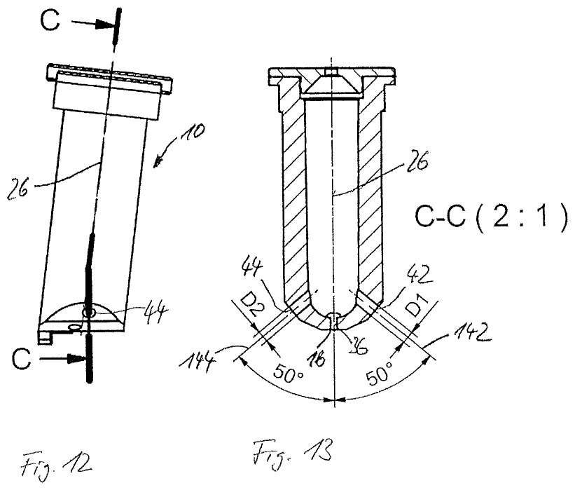

FIG. 11 shows a view onto the section plane B-B. It can be seen that the central longitudinal axis 26 in FIG. 11 is illustrated so as to be tilted by 7° to the vertical, in the clockwise manner. To be seen in FIG. 11 is the exit duct 36, the longitudinal axis 136 thereof thus running vertically in FIG. 11. The exit duct 136 has a circular cross section having the diameter D0.

The configuration of the aperture 14 can also be seen in more detail in the illustration of FIG. 11. The aperture 14 has the passage opening 32 which however is configured so as to be cylindrical only in a small portion. The diameter of the associated passage duct thereafter widens abruptly such that the passage duct, proceeding from the passage opening 32, opens out in a face that is disposed so as to be perpendicular to the central longitudinal axis 26. Said face is configured so as to be circular and said face is the cover face of a frustoconical clearance 132 which widens to the diameter of the exit chamber 126 of the nozzle 10. The exit chamber 126 is embodied so as to be circular-cylindrical and is configured so as to be hemispherical only in the lower end region thereof in FIG. 11, from where the exit ducts which lead to the exit openings proceed.

FIG. 12 shows a lateral view of the nozzle 10, wherein the central longitudinal axis 26 of the nozzle 10 in relation to the view of FIG. 1 and of FIG. 5 in the clockwise manner is tilted by 7° away from the vertical.

A section profile C-C which initially runs such that said section profile C-C contains the central longitudinal axis 26 but then is kinked by 7° such that said section profile C-C contains the longitudinal axes of the exit duct 44 and of the exit duct 42 is likewise plotted in FIG. 12.

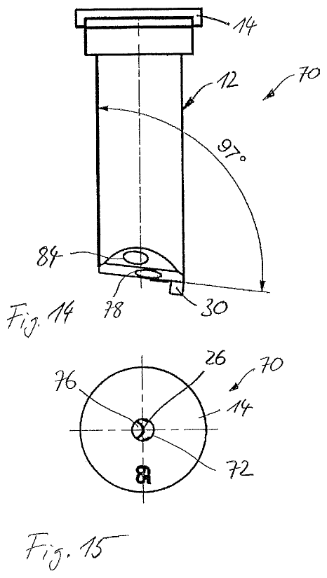

FIG. 13 shows a view onto the section profile C-C in FIG. 12. The exit duct 36 having the assigned exit opening 16 as well as the exit ducts 44, 42 having the assigned longitudinal axes 144, and 142, respectively, can be seen in portions. The longitudinal axes 144, 142 of the exit ducts 44, 42 are inclined by +50°, or −50°, respectively, to the central longitudinal axis 26. The exit duct 44 has a circular cross section having a diameter D2. The exit duct 42 has a circular cross section having the diameter D1, wherein D1 is larger than D2. The exit duct 36 has a circular cross section having the diameter D0, wherein D0 is larger than D1 and is larger than D2.

The illustration of FIG. 14 shows a nozzle 70 according to the invention, according to a second embodiment of the invention. The nozzle 70 for dispersing liquids, in particular liquid fertilizer, in comparison to the nozzle 10 of FIG. 1 is provided for discharging larger quantities of liquid, in particular liquid fertilizer. Otherwise, the construction of the nozzle 70 is fundamentally identical to that of the nozzle 10 of FIG. 1. Identical elements of the nozzles 10, 70 are therefore identified by the same reference signs and typically not explained again. Only the features which are different from those of the nozzle 10 of FIG. 1 will be discussed.

It can already be seen in FIG. 14 that the two exit openings 78, 84 to be seen in FIG. 14 have a larger diameter than the exit openings 18, 24 of the nozzle 10 of FIG. 1. It can moreover be seen that the exit openings 78, 84 have an elliptic cross section.

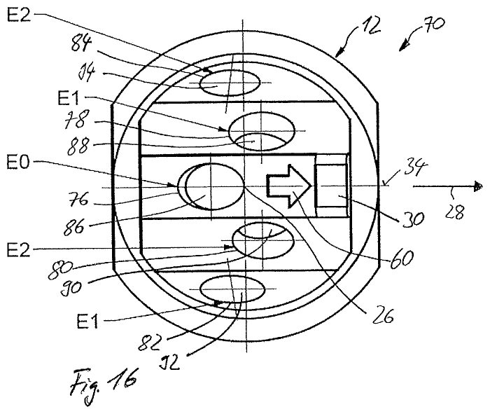

FIG. 15 shows a plan view of the nozzle 70 of FIG. 14. The aperture 14 is provided with a passage opening 72 which in relation to the passage opening 32 of the nozzle 10 of FIGS. 1 and 2 has a larger diameter.

It can be seen in FIG. 15, in which the view in a manner parallel with the longitudinal axis 26 of the exit chamber runs into the exit chamber, that a first exit opening 76 of the housing 12 is offset in relation to the passage opening 72 in the aperture 14. The first exit opening 76 can only be seen in portions through the passage opening 72. On account thereof, a jet of liquid generated by means of the passage opening 72 is prevented from cleanly shooting through.

FIG. 16 shows the nozzle 70 of FIG. 14 in a view from below. The nozzle 70 has a total of five exit openings 76, 78, 80, 82, 84 which all have an elliptic cross section. The major of the semi-axes of the elliptic cross section in the case of all exit openings 76, 78, 80, 82, 84 is disposed so as to be parallel with the envisaged direction of movement 28. In this way, large free cross sections and thus large quantities of discharged liquid can be achieved without the fan-shaped spray pattern generated by the nozzle 70 becoming overall wider than the fan-shaped spray pattern generated by the nozzle 10 of FIG. 1.

The first exit opening 46 is disposed at the end of a first exit duct 86, the longitudinal axis thereof lying in the central plane 34, wherein the longitudinal axis in relation to the longitudinal axis 26 of the exit chamber is inclined towards the rear by an angle between 40 and 10°, in particular 7°, counter to the envisaged direction of movement 28. The first exit duct 86 has a free cross section E0.

The second exit opening 78 is disposed at the end of a second exit duct 88, the longitudinal axis thereof being inclined by a second angle to the central plane 34 and additionally, in relation to the longitudinal axis 26, inclined towards the rear by an angle between 4° and 10°, in particular 7°, counter to the direction of movement 28. The second exit duct 88 has a free cross section E1.

The third exit opening 80 is disposed at the end of a third exit duct 90 which is inclined by a third angle to the central plane 34 and additionally is inclined by an angle of 4° to 10°, in particular 7°, to the longitudinal axis 26, counter to the direction of movement 28. The third angle is of identical size as the second angle, but in terms of the algebraic sign is different. The second exit duct 88 and the third exit duct 90 are thus disposed so as to be symmetrical with the central plane 34. The third exit duct 90 has a free cross section E2 which is smaller than the free cross section E1 of the second exit duct 88. The longitudinal axes of the second exit duct 88 and of the third exit duct 90 thus run so as to be symmetrical with the central plane 34, but a larger quantity of liquid is discharged from the second exit duct 88 than from the third exit duct 90. The free cross section E0 of the first exit duct 86 is larger than the free cross section E1 of the second exit duct 88 and larger than the free cross section E2 of the third exit duct 90. The free cross section E1 is larger than the free cross section E2.

The fourth exit opening 82 is disposed at the end of a fourth exit duct 92 which is inclined at a fourth angle to the central plane 34 and additionally is inclined at an angle between 40 and 10°, in particular 7°, to the longitudinal axis 26, counter to the direction of movement 28. The fourth exit duct 92 has a free cross section E1 which corresponds to the free cross section E1 of the second exit duct 88.

The fifth exit opening 44 is disposed at the end of a fifth exit duct 94, the longitudinal axis thereof being inclined at a fifth angle to the central plane 34 and additionally being inclined by an angle between 40 and 10°, in particular 7°, to the longitudinal axis 26, counter to the direction of movement 28. The longitudinal axes of the fourth exit duct 92 and of the fifth exit duct 94 are thus disposed so as to be symmetrical with the central plane 34. The free cross section E2 of the fifth exit duct 94 is however smaller than the free cross section E1 of the fourth exit duct 92 such that in the operation of the nozzle 70 a smaller quantity of liquid is discharged from the fifth exit duct 94 than from the fourth exit duct 92. The spray pattern of the nozzle 70 thus is not symmetrical with a plane with contains the central longitudinal axis 26 and the envisaged direction of movement 28. All exit ducts 86, 88, 90, 92, 94 have an elliptical cross-section.

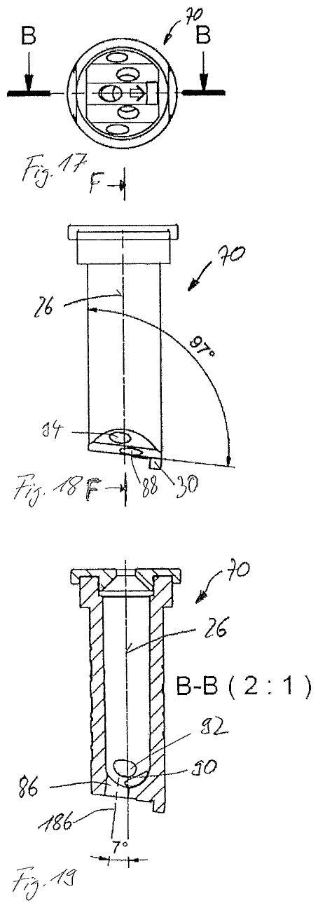

FIG. 17 shows the nozzle 70 of FIG. 14 in a view corresponding to that of FIG. 16, wherein a section plane B-B which contains the envisaged direction of movement of the nozzle 70 as well as the central longitudinal axis 26 of the nozzle 70, and which in the operation of the nozzle 70 is disposed so as to be perpendicular to a ground surface, is additionally plotted.

FIG. 18 shows a lateral view of the nozzle 70, corresponding to that of FIG. 14, wherein a section plane C-C is additionally plotted. The section plane C-C contains the central longitudinal axis 26 of the nozzle 70 and is disposed so as to be perpendicular to an envisaged direction of movement of the nozzle 70, and in the operation of the nozzle 70 is disposed so as to be perpendicular to a ground surface.

FIG. 19 shows a view onto the section plane B-B in FIG. 17. To be seen is the exit duct 86, the longitudinal axis 186 of which in relation to the central longitudinal axis 26 being inclined by 7° in the clockwise manner. This also applies to the longitudinal axes of the other exit ducts 88, 90, 92, 94, wherein only the exit ducts 90, 92 can be seen in portions in the illustration of FIG. 19.

The spray jets in terms of an envisaged direction of movement 28 of the nozzle 70 thus exit from the five exit openings 76, 78, 80, 82, 84 of the nozzle 70 so as to be inclined towards the rear by 7°, counter to the vertical. This has the effect that the spray jets in the case of usual spacings of the nozzle 70 from a ground surface impact the ground surface approximately perpendicularly.

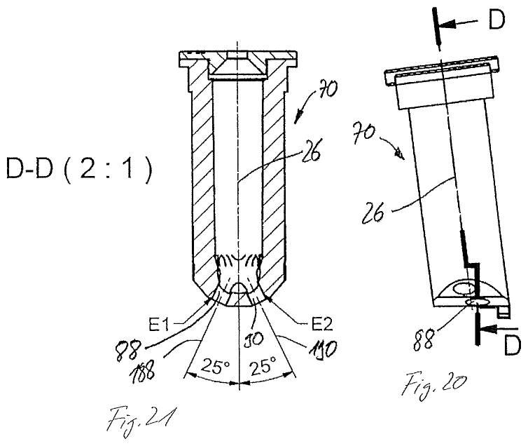

FIG. 20 shows a lateral view of the nozzle 70 which in the anti-clockwise manner is inclined by 7° to the vertical. A section profile D-D is plotted in FIG. 20. The section profile D-D, when viewed from the top, initially follows the central longitudinal axis 26 but then has a step, so as to then run such that said section profile D-D contains the longitudinal axes of the exit ducts 88, 90, wherein the exit duct 90 cannot be seen in FIG. 20.

FIG. 21 shows a view onto the section profile D-D. It can be seen that the longitudinal axis 188 of the exit duct 88 in the clockwise manner is inclined by 25° to the central longitudinal axis 26, and that the longitudinal axis 190 of the exit duct 90 in the anti-clockwise manner is inclined by 25° to the central longitudinal axis 26. It can furthermore be seen that the exit duct 80 has a cross section E1 which is elliptic, as has already been described, and that the exit duct 90 has a likewise elliptic cross section E2. The cross section E2 is smaller than the cross section E1. In operation, a smaller quantity of liquid fertilizer will thus exit from the exit duct 90 than from the exit duct 88. The spray pattern of the nozzle 70 thus is not symmetrical with a central plane which contains the central longitudinal axis 26 and the envisaged direction of movement 28 of the nozzle 70.

FIG. 22 shows a view of the nozzle 70 from the rear, thus in the envisaged direction of movement. In FIG. 14, this would be the view from the left onto the nozzle 70. A section plane E-E which contains the envisaged direction of movement and the central longitudinal axis 26 of the nozzle 70, and which in the operation of the nozzle 70 is perpendicular to a ground surface, is plotted in FIG. 22.

FIG. 23 shows a view onto the section plane E-E in FIG. 22. The central longitudinal axis 26 in the clockwise manner is tilted by 7° to the vertical such that a longitudinal axis 186 of the exit duct 86 in FIG. 23 runs vertically downwards. The exit duct 86 has an elliptic cross section E0 which is larger than the cross section E1 and which is larger than the cross section E2.

The configuration of the aperture 14 can be seen in FIG. 23, this aperture 14 however differing from the aperture 14 of the nozzle 10 only in terms of a passage opening 72 of a larger cross section. The diameter of the circular passage opening 72 corresponds to the upper, smaller, diameter of the subsequent frustoconical clearance which widens to the diameter of the exit chamber.

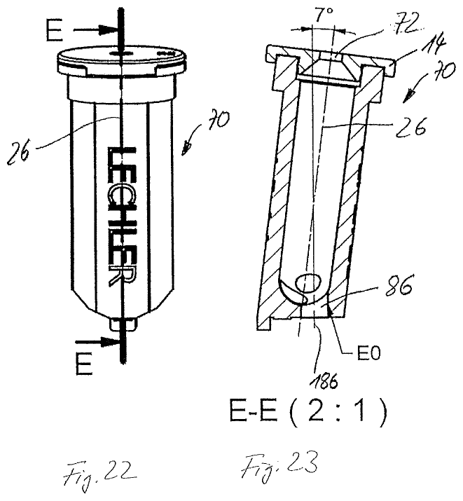

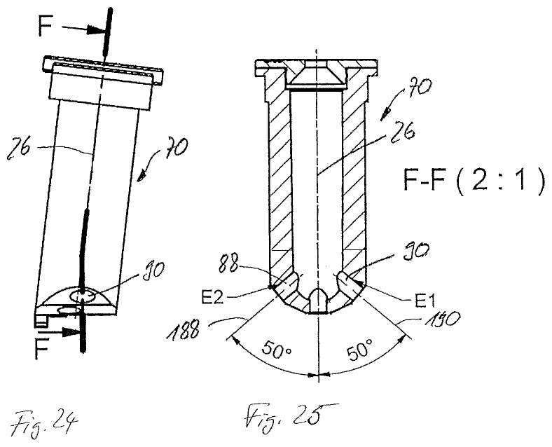

FIG. 24 shows a lateral view of the nozzle 70 which in relation to the lateral view of FIG. 14 in the clockwise manner is tilted by 7° to the vertical. A section profile F-F is plotted in FIG. 24. The section profile F-F initially follows the central longitudinal axis 26 of the nozzle 70, but is then kinked such that the section profile F-F contains the longitudinal axes of the exit ducts 90, 88, wherein the exit duct 88 cannot be seen in FIG. 24.

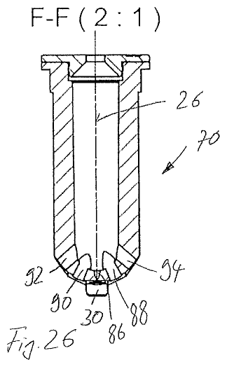

FIG. 25 shows a view onto the section profile F-F in FIG. 24. It can be seen that the longitudinal axis 188 of the exit duct 88 is disposed at an angle of −50°, thus in the clockwise manner, to the central longitudinal axis 26 of the nozzle 70. The longitudinal axis 190 of the exit duct 90 in relation to the central longitudinal axis 26 is inclined by an angle of +500, thus in the anti-clockwise manner. The exit duct 88 has an elliptic cross section E2, and the exit duct 90 has an elliptic cross section E1. The cross section E1 is larger than the cross section E2. In the operation of the nozzle 70, a larger quantity of liquid is thus discharged from the exit duct 90 than from the exit duct 88. The spray pattern of the nozzle 70 thus is not symmetrical with a plane which contains the central longitudinal axis 26, and which in the operation of the nozzle 70 contains the direction of movement 28 of the nozzle, and which is disposed so as to be perpendicular to a ground surface.

FIG. 26 shows a view onto the section plane F-F in FIG. 18. It can be seen by means of FIG. 18 that the section plane F-F intersects the exit ducts 88 and 94, but does not intersect the central axes of said exit ducts 88 and 94. This is because the exit ducts 88 and 94 run so as to be inclined by 7° to the central longitudinal axis 26; compare also FIGS. 17 and 19. The sectional view of FIG. 26 therefore shows only a portion of the exit ducts 88, 94 as well as 90 and 92. Only a very small fragment of the exit duct 86 can be seen in the illustration of FIG. 26. It can be seen in FIG. 26 that the free cross sections of the exit ducts 88 and 90 are of dissimilar sizes. While the exit ducts 88 and 90 are indeed inclined at the same angle relative to the central axis 26, the exit duct 88 however has a free cross section E1, whereas the exit duct 90 has a free cross section E2, and wherein the cross section E1 is larger than the cross section E2.

The two exit ducts 92, 94 in terms of the orientation of the respective central longitudinal axis thereof are also disposed so as to be symmetrical with the central longitudinal axis 26, but said two exit ducts 92, 94 have dissimilar cross sections. The exit duct 92 has a free cross section E1, and the exit duct 94 has a free cross section E2, wherein E1 is larger than E2.

1. Nozzle for dispersing liquids, in particular liquid fertilizer, having a housing having a liquids inlet, an exit chamber, and at least a first exit duct, a second exit duct, and a third exit duct, wherein the exit ducts proceed from the exit chamber, wherein a longitudinal axis of the first exit duct lies in a central plane of the housing, wherein the second exit duct is disposed at a second angle to the central plane, wherein a longitudinal axis of the third exit duct is disposed at a third angle to the central plane, said third angle in terms of the value being identical to the second angle but in terms of the algebraic sign being different therefrom, wherein a free cross section of the second exit duct and a free cross section of the third exit duct are dissimilar such that in the operation of the nozzle dissimilar quantities of liquid are discharged from the second exit duct and the third exit duct.

2. Nozzle according to claim 1, wherein a fourth exit duct and a fifth exit duct which proceed from the exit chamber are provided, wherein a longitudinal axis of the fourth exit duct is disposed at a fourth angle to the central plane, wherein a longitudinal axis of the fifth exit duct is disposed at a fifth angle to the central plane, wherein the fourth angle and the fifth angle are different from the second and the third angle, wherein the fourth angle and the fifth angle in terms of the value are identical but in terms of the algebraic sign are different, and wherein a free cross section of the fourth exit duct and a free cross section of the fifth exit duct are dissimilar such that in the operation of the nozzle dissimilar quantities of liquid are discharged from the fourth exit duct and the fifth exit duct.

3. Nozzle according to claim 2, wherein the free cross section of the second exit duct and of the fourth exit duct are identical, and in that the free cross section of the third exit duct and of the fifth exit duct are identical such that in the operation of the nozzle identical quantities of liquid are discharged from the second exit duct and the fourth exit duct, and that identical quantities of liquid are discharged from the third exit duct and the fifth exit duct.

4. Nozzle according to claim 1, where an aperture having at least one passage opening is disposed in the exit chamber, and in that the beginning of the first exit duct, when viewed in the flow direction through the exit chamber, is offset in relation to the passage opening.

5. Nozzle according to claim 1, wherein at least one of the exit ducts, when viewed perpendicularly to the central plane, is inclined by a sixth angle between 4 degrees and 10 degrees, in particular seven degrees, in relation to the central longitudinal axis the housing.

6. Nozzle according to claim 5, wherein all exit ducts in the spraying operation of the nozzle in relation to the vertical and to an envisaged direction of movement are inclined towards the rear by the sixth angle.

7. Nozzle according to claim 1, wherein the housing at the lower end thereof where the exit ducts open into the environment is provided with a protrusion which in an envisaged direction of movement lies in front and which protrudes from the housing approximately in the direction of the central longitudinal axis of the exit chamber.

8. Nozzle according to claim 1, wherein a cross section of at least one of the exit ducts is elliptic.

9. Nozzle according to claim 7, wherein a major of the semi-axes of the ellipse is disposed so as to be parallel with the envisaged direction of movement of the nozzle.

10. Agricultural spray device having a plurality of nozzles according to claim 1, wherein the exit ducts in relation to a forward travel direction of the spray device are inclined towards the rear at an angle between 4 degrees and 10 degrees, in particular 7 degrees, to the vertical.
